(19) United States
(12) Patent Application Publication
(10) Pub. No.: US 2015/0019321 A1
(43) Pub. Date: Jan. 15, 2015

(54) USING UNIVERSAL PRODUCT CODE TO RETRIEVE COUPONS AT CHECKOUT

(71) Applicants: Paul G. Begum, Laguna Niguel, CA (US); Yousef Abed, Irvine, CA (US)

(72) Inventors: Paul G. Begum, Laguna Niguel, CA (US); Yousef Abed, Irvine, CA (US)

(73) Assignee: KLEVER MARKETING, INC., Llguna Niguel, CA (US)

(21) Appl. No.: 14/045,639

(22) Filed: Oct. 3, 2013

Related U.S. Application Data
(60) Provisional application No. 61/845,930, filed on Jul. 12, 2013.

(51) Int. Cl. G06Q 30/02

(52) U.S. Cl. CPC G06Q 30/0238
USPC 705/14.38

(57) ABSTRACT

An online coupon source can create mappings between UPCs and consumers. The mapped UPCs can then be provided to the consumers' mobile devices for display during checkout. After a retailer system scans a mapped UPC during checkout, it sends the mapped UPC to the online coupon source. The online coupon source uses the mapped UPC to identify the consumer and to retrieve the consumer's applicable coupons for use during checkout. Once a mapped UPC has been used to retrieve coupons, the mapped UPC can be unmapped to allow the UPC to be mapped to another consumer. A retailer system can send a mapped UPC in response to a tender type being selected during checkout.

### CROSS-REFERENCE TO RELATED APPLICATIONS

This application claims the benefit of U.S. Provisional Patent Application No. 61/845,930 which was filed on Jul. 12, 2013.

This application is related to U.S. patent application Ser. No. 13/926,997, which was filed on Jun. 25, 2013, and is titled Clearinghouse For Electronic Coupons. This related application describes various implementations of a clearinghouse for processing electronic coupons and is an example of the type of system with which the present invention can interact to use a universal product code (UPC) to identify a consumer when redeeming coupons at checkout. A description of this clearinghouse is provided below. The invention, however, is generally directed to the functionality provided at an online coupon source and the point-of-sale (POS) system to enable such POS systems to use UPC codes to identify a consumer at checkout, and therefore, the invention should not be limited to interacting with any particular clearinghouse system. For example, the online coupon source can be integrated into or separate from a clearinghouse system. Similarly, the present invention can be implemented even when a typical clearinghouse requiring submission of paper coupons is used by a retailer to redeem coupons.

### BACKGROUND

Various clearinghouses for paper coupons exist. These clearinghouses function as an intermediary between the manufacturers that issue the paper coupons and the retail outlets that accept the paper coupons. When a customer redeems a coupon at a retail outlet, the retail outlet can send the coupon to the clearinghouse. The clearinghouse then interacts with the manufacturer that issued the coupon to receive reimbursement for the coupon. The reimbursement is then passed on to the retailer. For their services, clearinghouses generally retain a percentage of the reimbursements.

Although these clearinghouses work well with paper coupons, paper coupons are increasingly being replaced with electronic coupons. An electronic coupon is a coupon in a digital format. Electronic coupons can be distributed in various ways including by email, text, or mobile applications. Current clearinghouses for paper coupons have not provided an adequate solution for processing electronic coupons.

One difficulty that arises with electronic coupons when compared to paper coupons is that when a customer uses an electronic coupon at a retail outlet, the retail outlet does not receive a tangible item (i.e. paper) that can be sent to a clearinghouse. To address this issue, when many retailers accept an electronic coupon, they will print a copy of the coupon that can be sent to a clearinghouse for redemption. This step of printing a copy of each electronic coupon adds much difficulty to the coupon redemption process.

### BRIEF SUMMARY

The present invention extends to methods, systems, and computer program products for enabling a UPC to be used to identify a consumer during checkout for the purpose of retrieving coupons stored in an online coupon source. An online coupon source can create mappings between UPCs and consumers. The mapped UPCs can then be provided to the consumers' mobile devices for display during checkout. After a retailer system scans a mapped UPC during checkout, it sends the mapped UPC to the online coupon source. The online coupon source uses the mapped UPC to identify the consumer and to retrieve the consumer's applicable coupons for use during checkout. Once a mapped UPC has been used to retrieve coupons, the mapped UPC can be unmapped to allow the UPC to be mapped to another consumer.

In one embodiment, the present invention is implemented as a method, performed by a retailer system, for using a UPC to retrieve coupons from an online coupon source at checkout. A UPC displayed on a first consumer's mobile device is scanned by a retailer system. The UPC is processed to identify that the UPC is associated with an online coupon source that stores electronic coupons for the first consumer. The UPC is transmitted to the online coupon source. One or more of the first consumer's coupons are then received. The one or more coupons are associated, by the online coupon source, with the UPC.

In another embodiment, the present invention is implemented as a method, performed by an online coupon source, for creating a mapping between a UPC and a consumer for whom the online coupon source stores coupons. A request for a UPC is received from a mobile device of a first consumer. A mapping between the first consumer and a first UPC is created. The first UPC is transmitted to the mobile device for display on the mobile device during checkout. The first UPC is received after the retailer system has scanned the first UPC on the mobile device. It is determined from the mapping that the first UPC is mapped to the first consumer. One or more coupons are identified as being associated with the mapping. The one or more coupons are then transmitted to the retailer system.

In another embodiment, the present invention is implemented as a retailer system. The retailer system comprises one or more UPC scanning components for scanning UPCs, one or more processors, and computer storage media storing computer executable instructions which when executed by the one or more processors: receive UPCs from the one or more UPC scanning components; identify whether a received UPC is associated with a product or with an online coupon source; when the UPC is associated with the online coupon source, transmit the UPC to the online coupon source to identify that a consumer is attempting to use one or more coupons stored by the online coupon source in an account of the consumer; and receive, from the online coupon source, one or more coupons of the consumer.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which a retailer system can communicate with a clearinghouse for electronic coupons;

FIG. 2 illustrates that a clearinghouse for electronic coupons can include an application programming interface through which a retailer system can submit electronic coupons for redemption;

FIG. 3 illustrates an example of a coupon redemption request submitted to a clearinghouse;

FIG. 4 illustrates an example computing environment in which a UPC can be used to identify a consumer when using coupons at checkout;

FIG. 5 illustrates an example of how an online coupon source can create associations between a consumer and a UPC;

FIG. 6 illustrates an example of how a retailer system can identify a UPC associated with an online coupon source and transmit the UPC to the online coupon source to retrieve a consumer's applicable coupons;

FIG. 7 illustrates a flowchart of an example method, performed by a retailer system, for using a UPC to retrieve coupons from an online coupon source at checkout; and

FIG. 8 illustrates a flowchart of an example method, performed by an online coupon source, for creating a mapping between a UPC and a consumer for whom the online coupon source stores coupons.

### DETAILED DESCRIPTION

The present invention extends to methods, systems, and computer program products for enabling a UPC to be used to identify a consumer during checkout for the purpose of retrieving coupons stored in an online coupon source. An online coupon source can create mappings between UPCs and consumers. The mapped UPCs can then be provided to the consumers' mobile devices for display during checkout. After a retailer system scans a mapped UPC during checkout, it sends the mapped UPC to the online coupon source. The online coupon source uses the mapped UPC to identify the consumer and to retrieve the consumer's applicable coupons for use during checkout. Once a mapped UPC has been used to retrieve coupons, the mapped UPC can be unmapped to allow the UPC to be mapped to another consumer.

In one embodiment, the present invention is implemented as a method, performed by a retailer system, for using a UPC to retrieve coupons from an online coupon source at checkout. A UPC displayed on a first consumer's mobile device is scanned by a retailer system. The UPC is processed to identify that the UPC is associated with an online coupon source that stores electronic coupons for the first consumer. The UPC is transmitted to the online coupon source. One or more of the first consumer's coupons are then received. The one or more coupons are associated, by the online coupon source, with the UPC.

In another embodiment, the present invention is implemented as a method, performed by an online coupon source, for creating a mapping between a UPC and a consumer for whom the online coupon source stores coupons. A request for a UPC is received from a mobile device of a first consumer. A mapping between the first consumer and a first UPC is created. The first UPC is transmitted to the mobile device for display on the mobile device during checkout. The first UPC is received after the retailer system has scanned the first UPC on the mobile device. It is determined from the mapping that the first UPC is mapped to the first consumer. One or more coupons are identified as being associated with the mapping. The one or more coupons are then transmitted to the retailer system.

In another embodiment, the present invention is implemented as a retailer system. The retailer system comprises one or more UPC scanning components for scanning UPCs, one or more processors, and computer storage media storing computer executable instructions which when executed by the one or more processors: receive UPCs from the one or more UPC scanning components; identify whether a received UPC is associated with a product or with an online coupon source; when the UPC is associated with the online coupon source, transmit the UPC to the online coupon source to identify that a consumer is attempting to use one or more coupons stored by the online coupon source in an account of the consumer; and receive, from the online coupon source, one or more coupons of the consumer.

### Example Computing Architecture

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

### Example Computer Environment

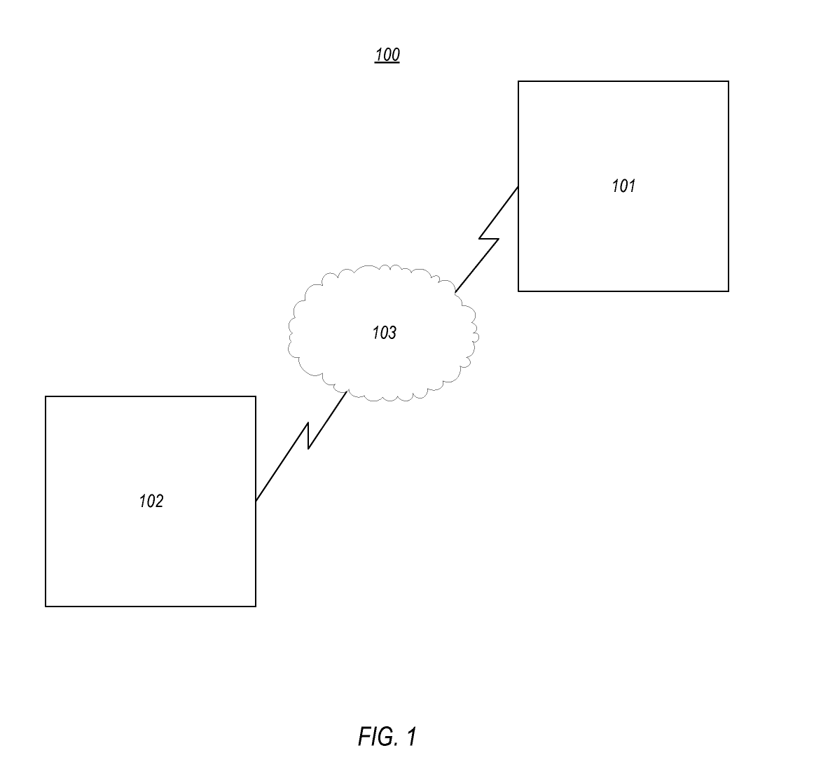

FIG. 1 illustrates an exemplary computer environment 100 in which a point-of-sale (or retailer) system can communicate with a clearinghouse for electronic coupons. Computer environment 100 includes clearinghouse system 101 and retailer system 102. Retailer system 102 is connected to clearinghouse system 101 via network 103. Network 103 represents any of the various types of network architectures known in the art.

In a typical example, network 103 includes the internet and a local area network used by retailer system 102 to connect to the internet. Retailer system 102 can communicate with clearinghouse system 101 over network 103 using any number and combination of various protocols as known in the art. Accordingly, the specific manner in which retailer system 102 communicates over network 103 is not essential to the invention.

Clearinghouse system 101 comprises one or more computer systems. In a particular example, clearinghouse system 101 can comprise a cloud of servers although any configuration of computer systems could be used to implement clearinghouse system 101.

Retailer system 102 also comprises one or more computer systems. In a particular example, retailer system 102 can comprise one or more servers that are integrated with one or more point-of-sale systems. For example, a retail outlet could have a single server located at the retail outlet that is connected to a plurality of point-of-sale terminals.

Alternatively, one or more servers could be located outside of a particular retail outlet such as when one or more common servers serve a plurality of retail outlets. Additionally, each individual point-of-sale terminal could also be configured to directly communicate with clearinghouse system 101.

Clearinghouse system 101 can provide an application programming interface that can be used by any computer system to communicate with clearinghouse system 101. In the remainder of the description, retailer system 102 will be referred to generally as describing any portion of the computer architecture implemented by a particular retailer to communicate with clearinghouse system 101 or any similar system for redeeming coupons. Point-of-sale terminal will be used to refer specifically to the components positioned at the checkout location which are used to scan UPCs of products. A point-of-sale terminal can therefore include self-checkout machines and traditional cashier-staffed checkout machines.

Providing a Clearinghouse for Electronic Coupons

When a customer visits a retail outlet and desires to use an electronic coupon, retailer system 102 can be used to accept the electronic coupon. An electronic coupon can be accepted in various ways such as by scanning a barcode displayed on the customer's mobile phone, or by otherwise entering an identifier of the coupon into retailer system 102.

Similarly, a customer's portable electronic device can be configured to automatically transfer coupons to retailer system 102. For example, a mobile application can be used to manage a customer's electronic coupons. The mobile application can be configured to interface with retailer system 102 (e.g. by scanning a barcode displayed on the phone, via a wireless connection such as Bluetooth, etc.) to transfer applicable coupons to retailer system 102 for use when the customer checks out at the retail outlet.

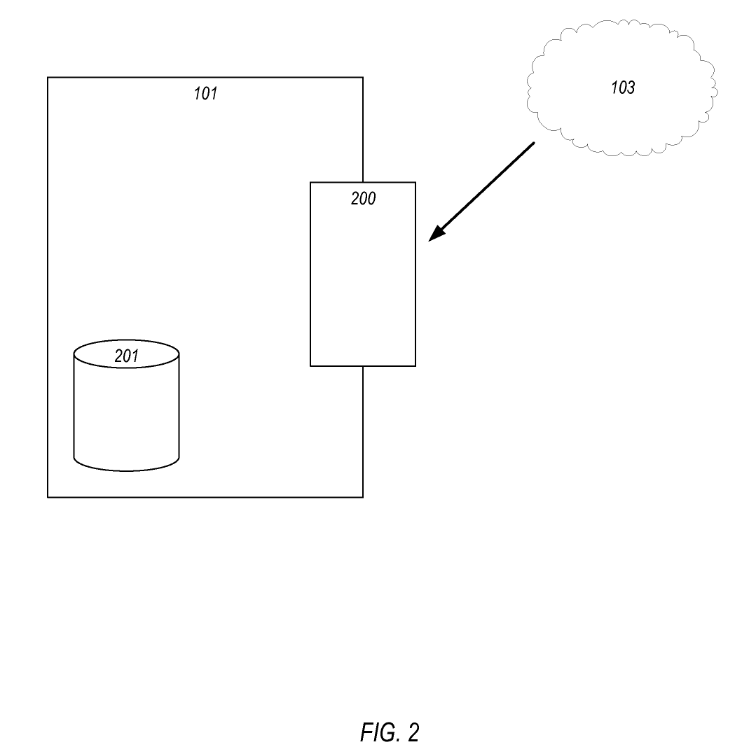

Regardless of the manner in which a customer's coupons are transferred to retailer system 102, retailer system 102 communicates with clearinghouse system 101 to redeem the coupons. As shown in FIG. 2, retailer system 102 can perform these communications automatically using application programming interface 200. Application programming interface 200 comprises an interface for submitting, over network 103, identifiers of coupons to clearinghouse system 101 for redemption.

FIG. 2 also illustrates that clearinghouse system 101 includes a coupon bank 201. Coupon bank 201 comprises a database that stores accounts for manufacturers, retailers, and or other coupon sources and distributors that offer coupons on their products. For example, if a manufacturer desires to offer coupons for one of the manufacturer's products, the manufacturer can create an account in coupon bank 201. Once the account is created, any number of retailer systems 102 can use application programming interface 200 to redeem coupons that are used to purchase the product against the account.

An account in coupon bank 201 specifies a quantity of coupons that the manufacturer will reimburse. For example, a manufacturer can specify that it will reimburse up to 100 coupons for product X. Alternatively, the manufacturer can specify that it will reimburse up to some dollar amount for coupons for product X. Accordingly, coupon bank 201 can maintain an account for coupons for product X having an initial balance of 100 (or the dollar equivalent if so specified).

As coupons are redeemed by retailer systems 102, coupon bank 201 deducts from the specified quantity in the account established for the coupons. For example, if retailer systems 102 submit five redemption requests for coupons for product X, coupon bank 201 can update the account for coupons for product X to have a balance of 95. In this way, an accurate, real-time balance is maintained for each coupon account.

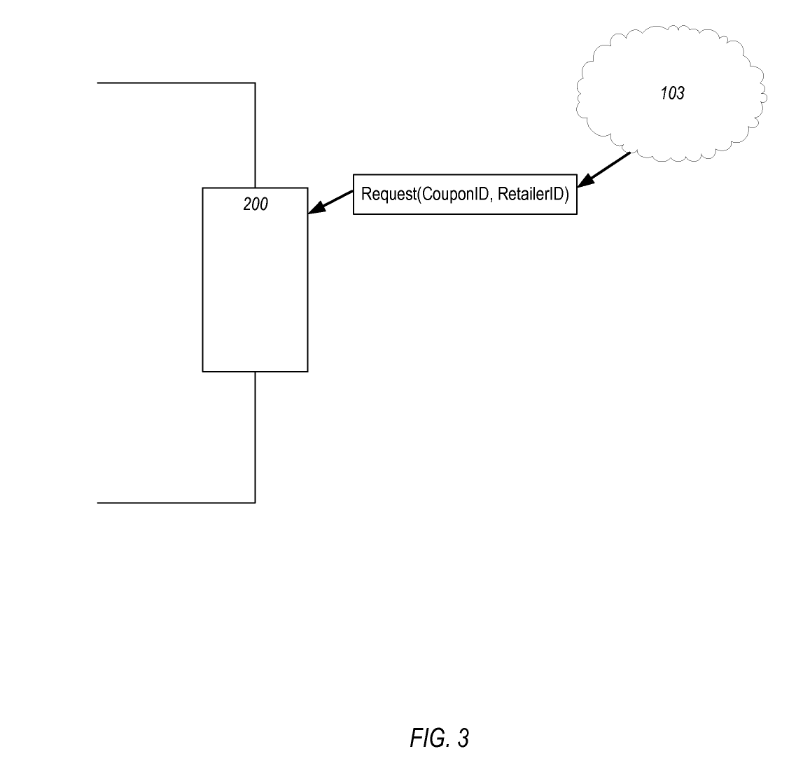

FIG. 3 illustrates an example of a coupon redemption request 300 submitted by retailer system 102 using application programming interface 200. As shown, request 300 includes an identifier of a coupon 301, and an identifier of the retailer system 302. In some embodiments, each individual coupon can have a unique identifier, or all coupons for the same product can share an identifier. In any case, coupon bank 201 is configured to understand the identifier of any coupon for which an account has been established. Identifier 301 is used to identify the appropriate account in coupon bank 200 to be used to reimburse the retailer for accepting the coupon. Identifier 302 is used to identify the particular retailer system 102 to which the reimbursement is to be credited.

In some embodiments, request 300 can include additional information regarding the coupon, product, retailer, etc. For example, if a coupon is applicable to a range of products, request 300 can specify which product was purchased with the coupon. Also, request 300 can specify the customer who used the coupon (e.g. a unique identifier of a customer's account or mobile device on which the coupon was displayed). Similarly, request 300 can identify the format of the coupon that was used (e.g. whether the coupon was in an email). Such information can be made available to the manufacturer to assist the manufacturer in determining the effectiveness of its coupons.

Clearinghouse system 101 can be used to provide immediate clearing of a coupon. For example, when a coupon is entered into retailer system 102, retailer system 102 can immediately send a request to clearinghouse system 101 via application programming interface 200. The request can be processed by coupon bank 201 to determine whether the coupon should be honored. For example, if a unique identifier is used on each coupon, coupon bank 201 can determine if the coupon has already been used (i.e. whether the current coupon is a copy) by comparing the identifier to the identifiers of previously used coupons. Coupon bank 201 can then determine whether to honor the coupon based on various criteria, such as manufacturer rules regarding copies of coupons, and notify retailer system 102 accordingly.

Similarly, coupon bank 201 can access the appropriate account to determine whether a balance remains for the coupon. For example, referring to the same example above, if 100 coupons had already been redeemed for product X (as evidenced by the balance of the account being zero), coupon bank 201 can notify retailer system 102 that the account for the coupon has already been exhausted. A manufacturer can specify rules that apply when an account balance has been exhausted. For example, a manufacturer may agree to reimburse the full amount of the coupon, a reduced percentage of the amount, or no amount. Coupon bank 201 can notify retailer system 102 of these rules to allow retailer system 102 to determine whether to honor the coupon. These notifications can be sent by clearinghouse system 101 to retailer system 102 immediately to allow retailer system 102 to make a decision regarding the coupon while the customer is checking out.

In some embodiments, clearinghouse system 101 can implement or interface with customer accounts. For example, a customer account can be used to store electronic coupons for a customer. When a customer uses an electronic coupon in his account, an identifier of the electronic coupon and/or of the customer can be included in the request sent to clearinghouse system 101. Clearinghouse system 101 can use this identifier to access the customer's account and remove the electronic coupon from the customer's account.

The clearinghouse system of the present invention provides a general interface (application programming interface 200) by which any retailer system can communicate with clearinghouse system 100 to redeem coupons. Accordingly, clearinghouse system 101 facilitates the process of accepting and redeeming electronic coupons. The clearinghouse system also increases the security of coupon redemption by providing real-time information regarding the validity of coupons and the manufacturer's agreement to reimburse coupons.

Using UPC to Identify a Consumer when Redeeming Coupons at Checkout

As described above, a clearinghouse for electronic coupons can allow a retailer to submit a consumer's electronic coupons for redemption. The above description states that coupons can be transferred from a consumer's computing device to a retailer system in various ways such as by scanning a code of the coupon displayed on the consumer's mobile phone, or otherwise receiving an identifier of a coupon from the consumer's mobile device. In each of these cases, the coupon originates with the consumer's mobile device. For example, even if the consumer maintains coupons online or obtains coupons from an online provider, as described above, the coupons would still be stored and/or displayed on the consumer's mobile device and then transferred from the mobile device to the retailer system.

In contrast, the present invention provides embodiments for using a UPC to identify a consumer for the purpose of obtaining coupons from an online coupon source. A consumer can maintain an account with an online coupon source and store coupons in this account. Then, when the consumer desires to use his coupons at checkout, the online coupon source can send a UPC to the consumer's mobile device which can then be displayed at checkout for scanning in a similar manner as a UPC on a product is scanned at checkout. After the UPC is scanned by the POS terminal, a communication including at least a portion of the UPC can be sent to the online coupon source. In response, the online coupon source can return the consumer's appropriate coupons to the POS terminal for processing. In this way, there is no need for the consumer's mobile device to display or otherwise transfer coupons to the retailer system at checkout.

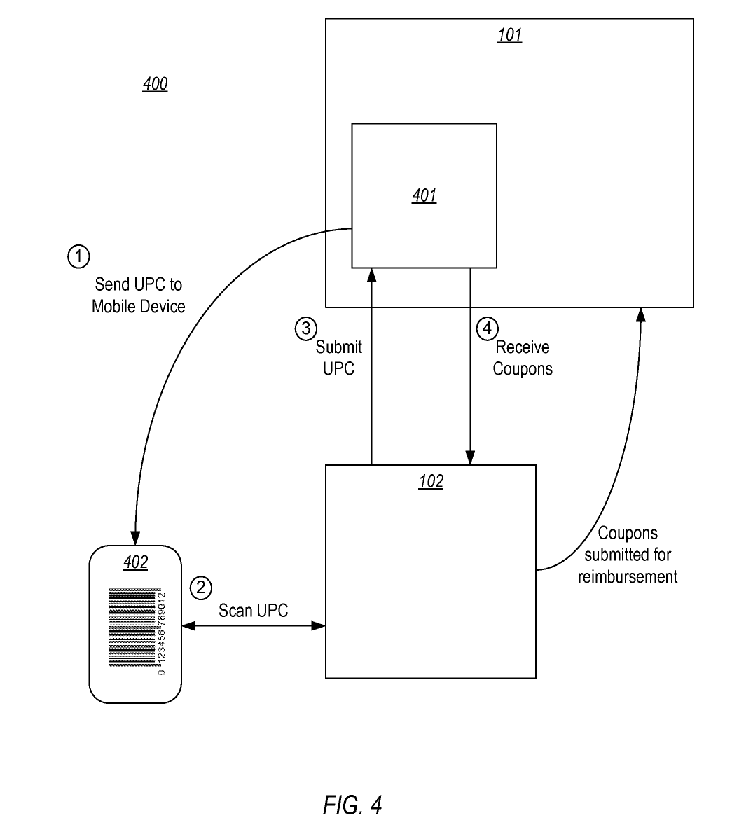

FIG. 4 illustrates an example computing environment 400 in which a UPC can be used to identify a consumer when using coupons at checkout. FIG. 4 also illustrates a number of steps that can be performed to enable a UPC to be used to retrieve a consumer's coupons. Computing environment 400 includes clearinghouse system 101, retailer system 102, and mobile device 402. Clearinghouse system 101 is shown as including online coupon source 401; however, online coupon source 401 could be separate from clearinghouse system 101 in other embodiments.

Online coupon source 401 can maintain a number of UPCs that have been reserved for use as consumer identifiers. When a consumer desires to use his coupons maintained in online coupon source 401, online coupon source 401 can associate a particular UPC with the consumer (e.g. with the consumer's account with online coupon source 401), and then send the UPC to the consumer's mobile device 402 (e.g. via an app on the mobile device). Then, when the consumer checks out, the consumer can display the UPC on mobile device 402 to allow the UPC to be scanned by retailer system 102.

Retailer system 102 can be configured to identify that the UPC is associated with online coupon source 401 and to transmit the UPC to online coupon source 401. When online coupon source 401 receives the UPC, it identifies the association between the UPC and the consumer, determines which of the consumer's coupons are to be transmitted back to retailer system 102, and then transmits these coupons to retailer system 102. Upon receiving the consumer's coupons from online coupon source 401, retailer system 102 can process the coupons in any manner including by submitting the coupons for redemption to clearinghouse system 101 as described above, by printing off the coupons and submitting the prints to a clearinghouse, or in some other manner.

In this way, a consumer's coupons are transferred directly from online coupon source 401 to retailer system 102 thereby eliminating the requirement that each coupon be scanned or otherwise transferred from mobile device 402. Further, because a UPC is used to identify the consumer, retailer system 102 requires minimal modifications to implement the present invention. In other words, a typical retailer system 102 will already be configured to scan UPCs on products as is standard in the industry. A typical retailer system can therefore be modified to include functionality for identifying certain UPCs as being associated with online coupon source 401, for submitting such UPCs when they are scanned during checkout, and for receiving coupons in response to the submission of a UPC. The remainder of the checkout process, including submission of the coupons for redemption, can be performed in a typical manner. Accordingly, the present invention can be particularly beneficial for updating existing point-of-sale systems in a simplified manner to perform automatic coupon retrieval.

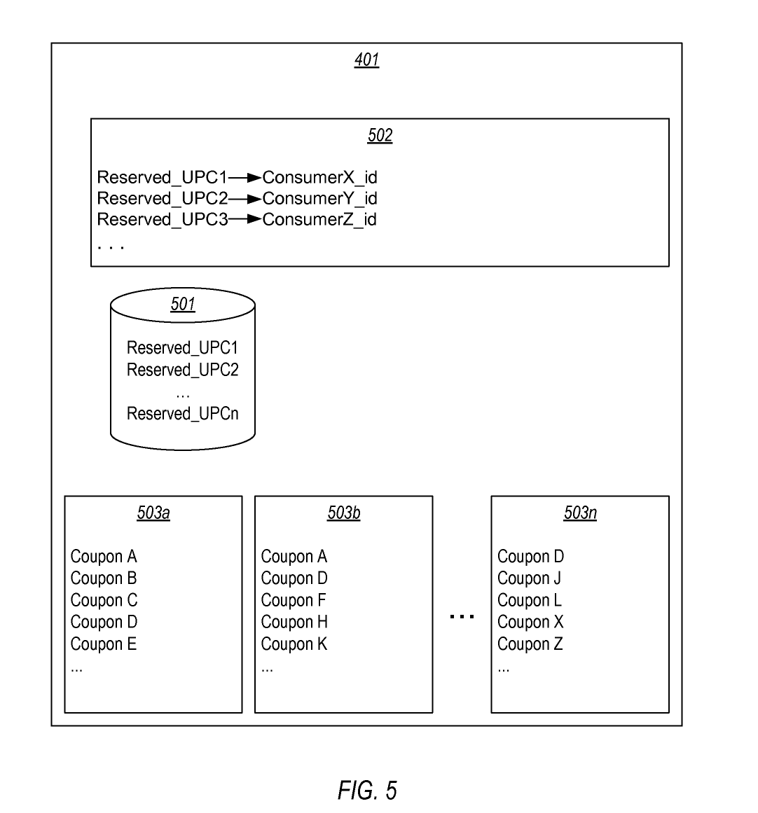

FIG. 5 illustrates an example of how online coupon source 401 can create associations between a consumer and a UPC. As shown, online coupon source 401 can include a database 501 which stores a plurality of reserved UPCs, a mapping table 502 defining current mappings between reserved UPCs and consumers, and a plurality of consumer accounts 503a-503n. Mapping table 502 is shown as including mappings between three reserved UPCs and consumers. For example, mapping table 502 maps Reserved_UPC1 to ConsumerX_id indicating that Reserved_UPC1 has been provided to the mobile device of the consumer identified by ConsumerX_id. Mapping table 502 is shown as an example representation of the functionality provided by online coupon source 401. However, any data structure or structures can be used to define mappings and associate coupons with the mappings.

While the consumer is checking out, the mapped UPC can be displayed on the consumer's mobile device. As described above, retailer system 102 can be configured to identify a UPC reserved by online coupon source 401. Therefore, after such UPCs are scanned, retail system 102 can transmit the reserved UPC to online coupon source 401. Online coupon source 401 then uses mapping table 502 to identify the consumer's account to which the UPC was mapped. Online coupon source 401 can then return appropriate coupons to retailer system 102 where they are applied to the consumer's total at checkout.

The determination of which coupons to send back to retailer system 102 can be performed in various ways. For example, in some embodiments, retailer system 102 can be configured to transmit the mapped UPC along with the UPCs of each product the consumer is purchasing (i.e. during checkout after retailer system 102 has scanned the consumer's products). Online coupon source 401 can then compare the UPCs of the consumer's products to the coupons in the consumer's account. Any applicable coupons can then be returned to retailer system.

Alternatively, in some embodiments, mappings between the products the consumer intends to purchase and the mapped UPC can be created prior to checkout. In such cases, each mapping in mapping table 502 can also include an indication of which of the consumer's coupons are associated with the mapping. For example, Reserved_UPC1 can be associated with Coupon A and Coupon D in Consumer X's account 503a. These associations define which of the consumer's coupons in the consumer's account will be transferred to retail system 102 when the mapped UPC is scanned and submitted.

In some embodiments, a coupon can be associated with a UPC when the consumer scans or otherwise identifies a product to which the coupon applies. Before or while a consumer is shopping, the consumer can scan or otherwise input products that the consumer intends to purchase. For example, while shopping, a consumer can use mobile device 402 to scan the UPC of one or more products that the consumer intends to purchase such as when placing the products in the consumer's shopping cart.

The consumer's mobile device can transfer the identification of these products to online coupon source 401 which can identify whether any of the consumer's coupons apply to any of the products. Any coupons that are identified as applying to one or more of the identified products can be identified for subsequent use. In some embodiments, a mapping between a reserved UPC and the consumer's identifier can be created at this time (i.e. when products are first identified) with the identified coupons being associated with the reserved UPC. However, in some embodiments, the reserving of a UPC can be postponed until the time of checkout (e.g. when the consumer provides input to the mobile device that he is ready to checkout), at which point, the identified coupons can be associated with the reserved UPC. In such embodiments, mapping table 502, or another data structure, may be used to initially store indications of the applicable coupons for a particular customer without a mapping to a reserved UPC with the reserved UPC being mapped to the customer and coupons at a later time.

In some embodiments, retailer system 102 can be further configured to transmit a confirmation to online coupon source 401 when a coupon is successfully used to allow online coupon source 401 to remove the used coupon from the consumer's account. In other embodiments, online coupon source 401 can be configured to automatically remove a coupon from a consumer's account once the coupon has been transmitted to a retailer system.

By using mapping table 502, the UPCs reserved by online coupon source 401 can be reused. In other words, because a potentially large number of consumers may use the present invention to retrieve their coupons, it may be desirable to shorten the duration of a mapping between a UPC and a particular consumer to enable fewer UPCs to be reserved at any given time. Accordingly, in some embodiments, a mapping between a UPC and a consumer can be created at the time of checkout. Then, once the coupons have been successfully transferred to retailer system 102, the mapping can be removed thereby freeing the previously mapped UPC for use in another mapping. In this way, a UPC will typically only be mapped to a particular consumer for the few minutes during which the consumer is checking out thereby allowing online coupon source 401 to reserve far fewer UPCs than would otherwise be required if mappings were made earlier during a consumer's shopping visit.

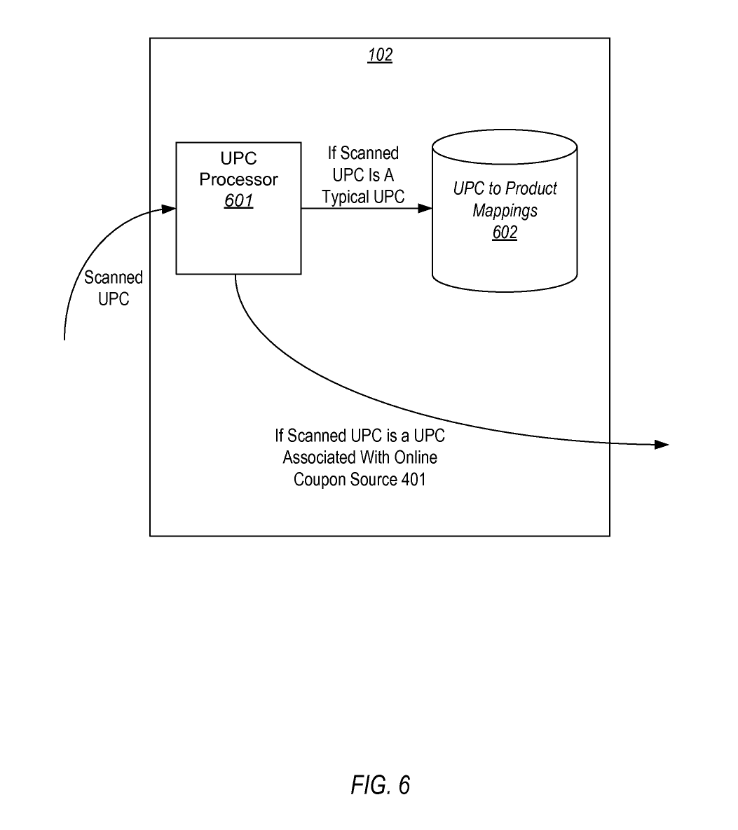

FIG. 6 illustrates an example of how retailer system 102 can identify a UPC associated with online coupon source 401 and transmit the UPC to online coupon source 401 to retrieve a consumer's applicable coupons. As shown, retailer system 102 can include a UPC processor 601 and a UPC to Product Mappings Database 602. Typically, when retailer system 102 scans a UPC, the UPC is used in a lookup to database 602 to retrieve the information about the product associated with the scanned UPC. In accordance with the present invention, UPC processor 601 can be configured to identify when a scanned UPC is associated with online coupon source 401 and to route such UPCs to online coupon source 401 to request the associated coupons. Accordingly, a typical POS system can be configured to enable implementation of the present invention with minor changes or updates.

Retailer system 102 can be configured to transmit a scanned UPC to online coupon source 401 at various times during checkout. In one embodiment, retailer system 102 can be configured to transmit the UPC as soon as it is scanned from mobile device 402. In such embodiments, once the user presents the UPC being displayed on mobile device 402 and the UPC is scanned, retailer system 401 can request the user's coupons by transmitting the UPC to online coupon source 401.

In other embodiments, retailer system 102 can be configured to transmit a scanned UPC in response to an event other than the scanning of the UPC. For example, in some embodiments, retailer system 102 can be configured to transmit a scanned UPC in response to a request to input a tender. Tender refers to the types of payment that can be received and processed by a point of sale system. For example, typical tender types include cash, check, credit, and debit.

In some embodiments, retailer system 102 can provide a special tender type that corresponds to coupons provided by online coupon source 401. In such cases, when the cashier or user selects the special tender type (e.g. by selecting a user interface element on a display terminal), retailer system 102 can transmit the previously scanned UPC to online coupon source 401 to retrieve the user's coupons.

In this way, the use of the coupons can be easily tracked as a particular type of tender. More particularly, because retailer system 102 is typically configured to generate an event when a particular tender type is selected, retailer system 102 can be configured to respond to the event generated when the special tender type is selected. This response can include obtaining the coupons from online coupon source 401 as described above as well as tracking the amount of the discount provided by the use of the coupons. In other words, tying the retrieval of the coupons to the selection of the special tender type facilitates tracking the use of the coupons for accounting of other purposes.

In some embodiments, the discount provided by the coupons can be deducted from the total purchase amount before or after taxes have been calculated on the total purchase amount. Tying the retrieval of the coupons to the selection of the special tender type facilitates deducting the discount from the total purchase amount because the option to select a tender type is typically displayed after all of the user's items have been scanned and a total purchase amount is known.

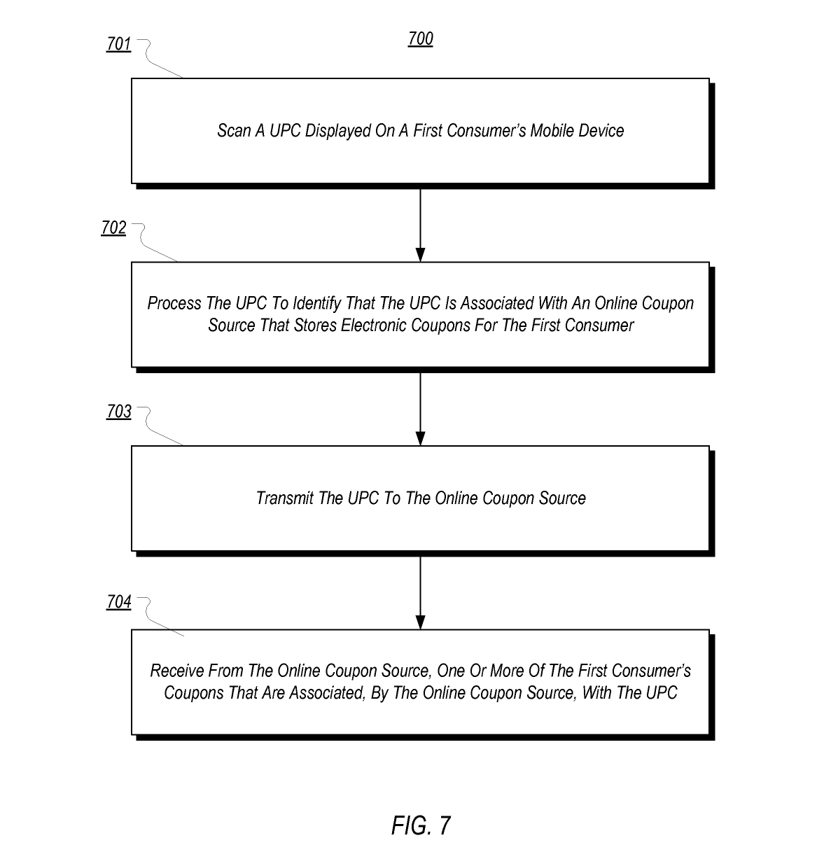

FIG. 7 illustrates a flowchart of an example method 700 for using a UPC to identify a consumer. FIG. 7 will be described with reference to FIGS. 4 and 6.

Method 700 includes an act 701 of scanning, by a retailer system, a UPC displayed on a first consumer's mobile device. For example, a POS terminal of retailer system 102 can be used to scan a UPC barcode that is displayed on the first consumer's smart phone 402.

Method 700 includes an act 702 of processing the UPC to identify that the UPC is associated with an online coupon source that stores electronic coupons for the first consumer. For example, UPC processor 601 can process the UPC to determine that the UPC is associated with online coupon source 401. Online coupon source 401 may or may not be incorporated into or associated with a clearinghouse, such as clearinghouse 101, used by retailer system 102 to redeem electronic coupons.

Method 700 includes an act 703 of transmitting the UPC to the online coupon source. For example, retailer system 102 can transmit the UPC to online coupon source 401

Method 700 includes an act 704 of receiving, from the online coupon source, one or more of the first consumer's coupons that are associated, by the online coupon source, with the UPC. For example, retailer system 102 can receive one or more of the first consumer's coupons from online coupon source 401.

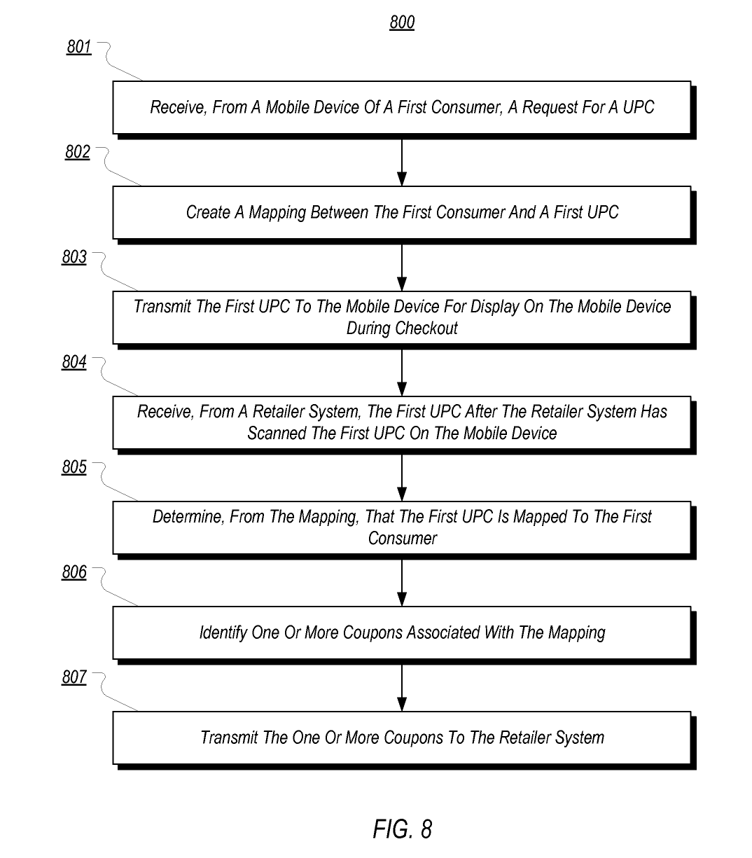

FIG. 8 illustrates a flowchart of an example method 800, performed by an online coupon source, for creating a mapping between a UPC and a consumer for whom the online coupon source stores coupons. Method 800 will be described with reference to FIGS. 4 and 5.

Method 800 includes an act 801 of receiving, from a mobile device of a first consumer, a request for a UPC. For example, online coupon source 401 can receive a request from mobile device 402 for a UPC.

Method 800 includes an act 802 of creating a mapping between the first consumer and a first UPC. For example, online coupon source 401 can identify an available (unmapped) UPC in database 501 and create a mapping in mapping table 502 between the available UPC and the first consumer.

Method 800 includes an act 803 of transmitting the first UPC to the mobile device for display on the mobile device during checkout. For example, online coupon source 401 can transmit the first UPC to mobile device 402.

Method 800 includes an act 804 of receiving, from a retailer system, the first UPC after the retailer system has scanned the first UPC on the mobile device. For example, online coupon source 401 can receive the first UPC from retailer system 102 when retailer system 102 scans the first UPC on mobile device 402 or when a special tender type is selected.

Method 800 includes an act 805 of determining, from the mapping, that the first UPC is mapped to the first consumer. For example, online coupon source can access mapping table 502 to locate the first UPC and to identify that the first UPC is mapped to the first consumer.

Method 800 includes an act 806 of identifying one or more coupons associated with the mapping. For example, online coupon source 401 can identify that the mapping includes or is associated with an identification of one or more of the first consumer's coupons stored by online coupon source 401.

Method 800 includes an act 807 of transmitting the one or more coupons to the retailer system. For example, online coupon source 401 can transmit the one or more coupons to retailer system 102 to be applied to the first consumer's total during checkout.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a retailer system, for using a universal product code (UPC) to retrieve coupons from an online coupon source at checkout, the method comprising:
scanning, by a retailer system, a UPC displayed on a first consumer's mobile device;
processing the UPC to identify that the UPC is associated with an online coupon source that stores electronic coupons for the first consumer;
transmitting the UPC to the online coupon source; and
receiving, from the online coupon source, one or more of the first consumer's coupons that are associated, by the online coupon source, with the UPC.

2. The method of claim 1, further comprising:
scanning, by the retailer system, the UPC of one or more products to generate an amount the first consumer must pay to purchase the one or more products; and
applying the one or more coupons to reduce the amount.

3. The method of claim 1, further comprising:
submitting, by the retailer system, the one or more coupons to a clearinghouse for redemption.

4. The method of claim 1, wherein processing the UPC to identify that the UPC is associated with an online coupon source that stores electronic coupons for the first consumer comprises identifying that a portion of the UPC is associated with the online coupon source.

5. The method of claim 1, wherein the UPC is transmitted to the online coupon source when the UPC is scanned.

6. The method of claim 1, wherein the UPC is transmitted to the online coupon source in response to receiving a selection of a tender type.

7. The method of claim 6, wherein the selection of the tender type is received after a total purchase amount is known for one or more products the first consumer is purchasing.

8. The method of claim 7, wherein the total purchase amount includes taxes for the purchase of the one or more products.

9. A method, performed by an online coupon source, for creating a mapping between a universal product code (UPC) and a consumer for whom the online coupon source stores coupons, the method comprising:
receiving, from a mobile device of a first consumer, a request for a UPC;
creating a mapping between the first consumer and a first UPC;
transmitting the first UPC to the mobile device for display on the mobile device during checkout;
receiving, from a retailer system, the first UPC after the retailer system has scanned the first UPC on the mobile device;
determining, from the mapping, that the first UPC is mapped to the first consumer;
identifying one or more coupons associated with the mapping; and
transmitting the one or more coupons to the retailer system.

10. The method of claim 9, wherein the request for the UPC is received while the first consumer is checking out with the retailer system.

11. The method of claim 9, wherein identifying one or more coupons associated with the mapping comprises:
receiving, from the mobile device, an identification of one or more products that the first consumer intends to purchase;
accessing an account of the first consumer to identify that the one or more coupons apply to one or more of the products; and
identifying the one or more coupons as applicable to the one or more products the first consumer intends to purchase.

12. The method of claim 11, wherein the identification of the one or more products the first consumer intends to purchase is received prior to creating the mapping between the first consumer and the first UPC, and wherein creating the mapping between the first consumer and the first UPC includes creating the association between the one or more coupons and the mapping.

13. The method of claim 11, wherein the identification of the one or more products the first consumer intends to purchase is received after creating the mapping between the first consumer and the first UPC.

14. The method of claim 9, wherein the first UPC is selected from a number of UPCs that the online coupon source has reserved.

15. The method of claim 14, further comprising:
after the one or more coupons are transmitted to the retailer system, unmapping the first UPC to enable the first UPC to be mapped to another consumer.

16. The method of claim 9, wherein the online coupon source maintains an account for the first consumer which stores the first consumer's coupons, the method further comprising:
removing the one or more coupons from the first consumer's account.

17. The method of claim 16, wherein the one or more coupons are removed from the first consumer's account in response to receiving a confirmation from the retailer system that the one or more coupons were used during checkout.

18. A retailer system comprising:
one or more UPC scanning components for scanning UPCs;
one or more processors; and
computer storage media storing computer executable instructions which when executed by the one or more processors perform the following:
receive UPCs from the one or more UPC scanning components;
identify whether a received UPC is associated with a product or with an online coupon source;
when the UPC is associated with the online coupon source, transmit the UPC to the online coupon source to identify that a consumer is attempting to use one or more coupons stored by the online coupon source in an account of the consumer; and
receive, from the online coupon source, one or more coupons of the consumer.

19. The retailer system of claim 18, wherein the UPC is transmitted to the online coupon source in response to receiving a selection of a tender type.

20. The method of claim 18, wherein the selection of the tender type is received after a total purchase amount is known for one or more products the first consumer is purchasing.
